(19) United States
(12) Patent Application Publication
(10) Pub. No.: US 2014/0291262 A1
(43) Pub. Date: Oct. 2, 2014

(54) PANEL AND BOOKCASE ASSEMBLY USING THE SAME

(71) Applicant: Byung Kil Choe, Seongnam (KR)

(72) Inventor: Byung Kil Choe, Seongnam (KR)

(21) Appl. No.: 13/850,797

(22) Filed: Mar. 26, 2013

(51) Int. Cl. A47B 63/00; B32B 3/30; B32B 38/00

(52) U.S. Cl. CPC A47B 63/00; B32B 38/0012; B32B 3/30
USPC 211/42; 156/226; 428/167

(57) ABSTRACT

Disclosed is a panel that includes: a board element formed from a rigid material and having at least one folding groove formed in a first surface thereof; and a surface laminate formed from a flexible material and coupled to a second surface of the board element opposite the first surface of the board element, where the folding groove comprises two triangular grooves, which are formed adjacent to and symmetrically to each other, and each of which is formed in a triangular shape with sides of substantially equal length, and the board element is folded at a particular angle at the folding groove such that the surface laminate is positioned outward and a chamfer is formed at a portion corresponding to the folding groove. This panel fabricated by a simple method using a smaller amount of material can still provide high structural stability and durability with improved user convenience and appearance.

### BACKGROUND

1. Technical Field

The present invention relates to a panel having chamfers, a method of fabricating the panel, and a bookcase assembled using the same.

2. Description of the Related Art

Our daily lives see the use of various types of furniture that are fabricated in various forms. In furniture such as tables, bookcases, and the like, high structural stability and durability are desirable characteristics.

In the past, a panel, etc., used in a piece of furniture was fabricated from natural wood, with the detailed features processed into the wood itself and a surface treatment applied afterwards. A piece of furniture fabricated from natural wood provides the advantages of structural stability, high durability, aesthetic appearance, and more.

However, the supply of natural wood has decreased in recent times, leading to high costs of wood. What is more, there is an increased awareness of the adverse effects on the environment caused by the consumption of natural resources such as wood. Thus, there is a need for a panel, for use in fabricating furniture, etc., that can provide sufficient structural stability while using a smaller amount of raw material.

One method of reducing the amount of material used is to make a frame from wood, etc., overlay a flat element over the frame, and apply a finishing material. This method can reduce the use of raw material, and with a proper design, can provide a panel that has high structural stability and a relatively lower weight. However, this method may require several processes in its implementation and may thus require high fabrication costs. Moreover, with this method, it may be difficult to process chamfers into the panel.

A chamfer refers to the edge of a panel, etc., in which the relatively sharper corner is cut off to provide an edge forming obtuse angles. In a panel intended for furniture, chamfers may be needed for the users' safety and convenience, and in cases where the panel is overlaid with a finishing material, chamfers can also be helpful in protecting the finishing material from wear and damage otherwise caused by the sharp edges.

As described above, there is a need for a panel for use in fabricating furniture that uses a smaller amount of material, provides structural stability, and includes chamfers, for greater convenience and a more pleasing appearance.

### SUMMARY

An aspect of the invention is to provide a panel, a method of fabricating the panel, and a bookcase assembled using the panel, where the panel can be fabricated by a simple method using a smaller amount of material while still providing high structural stability and durability.

Another aspect of the invention is to provide a panel, a method of fabricating the panel, and a bookcase assembled using the panel, where the panel includes chamfers for greater convenience and a more pleasing appearance.

One aspect of the invention provides a panel that includes: a board element formed from a rigid material and having at least one folding groove formed in a first surface thereof; and a surface laminate formed from a flexible material and coupled to a second surface of the board element opposite the first surface of the board element, where the folding groove comprises two triangular grooves, which are formed adjacent to each other and formed symmetrically to each other, and each of which is formed in a triangular shape with sides of substantially equal length, and the board element is folded at a particular angle at the folding groove such that the surface laminate is positioned outward and a chamfer is formed at a portion corresponding to the folding groove.

The angle between a first side of the triangular groove and the first surface and the angle between a second side of the triangular groove and the second surface can be such that satisfy the equation shown below:

α=90°−γ+x/2,

where α is the angle between the first side of the triangular groove and the first surface, γ is the angle between the second side of the triangular groove and the second surface, and x is the angle by which the board element is folded at the corresponding folding groove.

The folding groove can further include an auxiliary groove. The two triangular grooves can be formed within the auxiliary groove, and the angle between a side of the auxiliary groove and the first surface can form an angle of x/2, where x is the angle by which the board element is folded at the corresponding folding groove.

In one embodiment of the invention, the panel can further include a rounding piece positioned on the second surface of the board element between points corresponding to vertexes of the two triangular grooves. The rounding piece can have a cross section shaped as a circular segment and can extend along a longitudinal direction of the panel.

Another aspect of the invention provides a panel that includes: a board element formed from a rigid material and having at least one folding groove formed in a first surface thereof; a surface laminate formed from a flexible material and coupled to a second surface of the board element opposite the first surface of the board element; and a load-bearing element coupled to the first surface of the board element, where the folding groove comprises two triangular grooves, which are formed adjacent to each other and symmetrically to each other, and each of which is formed in a triangular shape with sides of substantially equal length, and the board element is folded at a particular angle at the folding groove to cover the load-bearing element such that the surface laminate is positioned outward and a chamfer is formed at a portion corresponding to the folding groove.

The angle between a first side of the triangular groove and the first surface and the angle between a second side of the triangular groove and the second surface can be such that satisfy the equation shown below:

α=90°−γ+x/2,

where α is the angle between the first side of the triangular groove and the first surface, γ is the angle between the second side of the triangular groove and the second surface, and x is the angle by which the board element is folded at the corresponding folding groove.

The folding groove can further include an auxiliary groove. The two triangular grooves can be formed within the auxiliary groove, and the angle between a side of the auxiliary groove and the first surface can form an angle of x/2, where x is the angle by which the board element is folded at the corresponding folding groove.

In one embodiment of the invention, the panel can further include a rounding piece positioned on the second surface of the board element between points corresponding to vertexes of the two triangular grooves. The rounding piece can have a cross section shaped as a circular segment and can extend along a longitudinal direction of the panel.

The load-bearing element can include linear members fixed in relation to one another, and the linear members can include longitudinal members arranged along a longitudinal direction of the panel at both sides and lateral members arranged along a lateral direction of the panel between the longitudinal members.

The board element can be attached to the load-bearing element by way of an adhesive material coated on at least a portion of the linear members.

The panel can have at least one coupling indentation for coupling with another panel, and the coupling indentation can be formed in a position where the linear member is arranged.

The load-bearing element can include at least one insertion indentation, and the board element can include at least one protrusion in a position corresponding to the insertion indentation, such that the protrusion may be inserted into the insertion indentation when the board element is folded, to secure the board element in relation to the load-bearing element.

Still another aspect of the invention provides a bookcase formed by coupling a multiple number of panels together. At least one of the panels includes a board element formed from a rigid material and having at least one folding groove formed in a first surface thereof, a surface laminate formed from a flexible material and coupled to a second surface of the board element opposite the first surface of the board element, and a load-bearing element coupled to the first surface of the board element. The folding groove includes two triangular grooves formed adjacent to each other, the triangular grooves formed symmetrically to each other and each formed in a triangular shape with sides of substantially equal length. Thus, the board element may be folded at a particular angle at the folding groove to cover the load-bearing element such that the surface laminate is positioned outward and a chamfer is formed at a portion corresponding to the folding groove. Here, at least one of the panels is arranged such that a portion corresponding to the folding groove is positioned at a front of the bookcase.

The angle between a first side of the triangular groove and the first surface and the angle between a second side of the triangular groove and the second surface can be such that satisfy the equation shown below:

α=90°−γ+x/2,

where α is the angle between the first side of the triangular groove and the first surface, γ is the angle between the second side of the triangular groove and the second surface, and x is the angle by which the board element is folded at the corresponding folding groove.

The folding groove can further include an auxiliary groove. The two triangular grooves can be formed within the auxiliary groove, and the angle between a side of the auxiliary groove and the first surface can form an angle of x/2, where x is the angle by which the board element is folded at the corresponding folding groove.

In one embodiment of the invention, the panel can further include a rounding piece positioned on the second surface of the board element between points corresponding to vertexes of the two triangular grooves. The rounding piece can have a cross section shaped as a circular segment and can extend along a longitudinal direction of the panel.

The load-bearing element can include linear members fixed in relation to one another, and the linear members can include longitudinal members arranged along a longitudinal direction of the panel at both sides and lateral members arranged along a lateral direction of the panel between the longitudinal members.

The board element can be attached to the load-bearing element by way of an adhesive material coated on at least a portion of the linear members.

The load-bearing element can include at least one insertion indentation, and the board element can include at least one protrusion in a position corresponding to the insertion indentation, such that the protrusion may be inserted into the insertion indentation when the board element is folded, to secure the board element in relation to the load-bearing element.

The panels can be coupled to one another at positions where the linear members are arranged.

Yet another aspect of the invention provides a method of fabricating a panel that includes: preparing a board element having a first surface, with which to form the inside, and a second surface, with which to form the outside; attaching a surface laminate to the second surface of the board element; processing at least one folding groove, which includes two adjacent triangular grooves, in the first surface of the board element; arranging a load-bearing element on the first surface of the board element adjacent to the folding groove; and folding the board element at the folding groove to cover the load-bearing element such that the surface laminate is positioned outward and a chamfer is formed at a portion corresponding to the folding groove.

Preparing the board element can include coupling a rounding piece to the second surface of the board element between points corresponding to vertexes of the two triangular grooves, where the rounding piece can have a cross section shaped as a circular segment and can extend along a longitudinal direction of the panel.

The method of fabricating a panel can further include coating an adhesive material on at least a portion of the load-bearing element, before arranging the load-bearing element.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a perspective view illustrating a panel according to an embodiment of the invention.

FIG. 2A is a perspective view illustrating a board element for a panel according to an embodiment of the invention.

FIG. 2B is a perspective view illustrating a load-bearing element for a panel according to an embodiment of the invention.

FIG. 3A is a cross-sectional view illustrating the board element of FIG. 2A and the load-bearing element of FIG. 2B arranged one over the other.

FIG. 3B is a cross-sectional view illustrating the board element of FIG. 3A folded at the folding grooves to cover the load-bearing element.

FIG. 3C is a cross-sectional view illustrating a board element with rounding pieces added according to an embodiment of the invention.

FIG. 3D is a cross-sectional view illustrating the board element of FIG. 3C folded at the folding grooves to cover the load-bearing element.

FIG. 4A and FIG. 4B are conceptual diagrams examining the relationships between the angles formed in a folding groove according to an embodiment of the invention.

FIG. 5A is a perspective view illustrating a board element for a panel according to another embodiment of the invention.

FIG. 5B is a cross-sectional view illustrating a panel using the board element of FIG. 5A.

FIG. 6A is a perspective view illustrating a board element for a panel according to another embodiment of the invention.

FIG. 6B is a cross-sectional view illustrating a panel using the board element of FIG. 6A.

FIG. 7A is a cross-sectional view illustrating a folding groove in a panel according to another embodiment of the invention.

FIG. 7B is a cross-sectional view illustrating a portion of a panel using the board element of FIG. 7A.

FIG. 8 is a perspective view illustrating a bookcase according to an embodiment of the invention.

FIG. 9 is a flowchart illustrating a method of fabricating a panel according to an embodiment of the invention.

### DETAILED DESCRIPTION

As the present invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In describing the drawings, like reference numerals are used for like elements.

While such terms as “first” and “second,” etc., may be used to describe various components, such components must not be limited to the above terms. The above terms are used only to distinguish one component from another. For example, a first component may be referred to as a second component without departing from the scope of rights of the present invention, and likewise a second component may be referred to as a first component. The term “and/or” encompasses both combinations of the plurality of related items disclosed and any item from among the plurality of related items disclosed.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Certain embodiments of the invention will be described below in more detail with reference to the accompanying drawings. Those components that are the same or are in correspondence are rendered the same reference numeral regardless of the figure number, and redundant descriptions are omitted.

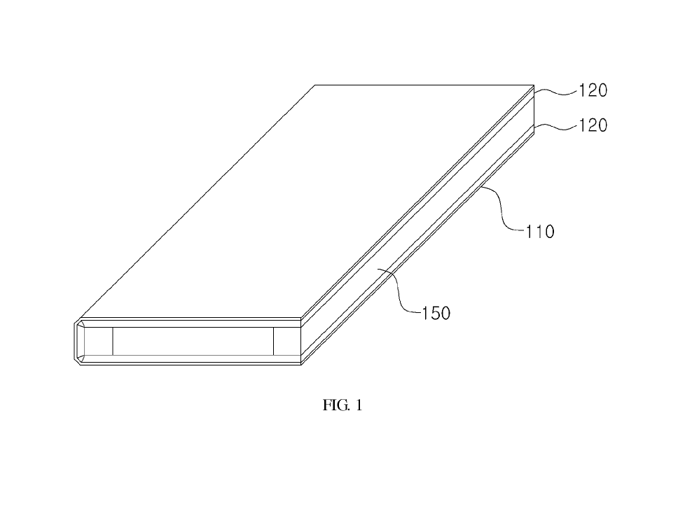

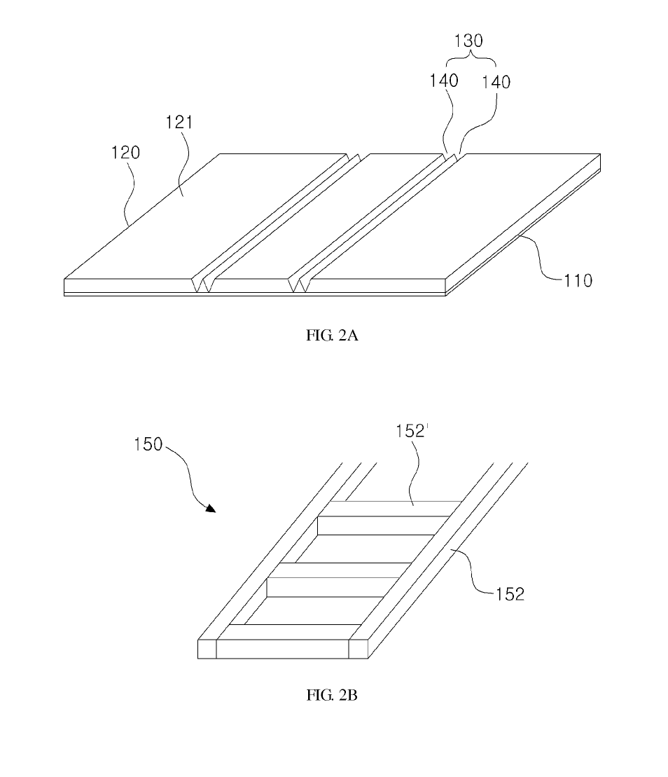

FIG. 1 is a perspective view illustrating a panel according to an embodiment of the invention, FIG. 2A is a perspective view illustrating a board element for a panel according to an embodiment of the invention, and FIG. 2B is a perspective view illustrating a load-bearing element for a panel according to an embodiment of the invention.

As illustrated in FIG. 1, a panel 100 according to an embodiment of the invention can be implemented in the form of a board element 120 covering a load-bearing element 150 and a surface laminate 110 surrounding the outer surface of the board element 120. As described later in further detail, folding grooves 130 can be formed in the board element 120, so that chamfers 115 may be formed in the edges of the panel 100.

Illustrated in FIG. 2A is a board element 120 for a panel 100 according to an embodiment of the invention. One or more folding grooves 130 may be formed in a first surface 121 of the board element 120, while the surface laminate 110 may be attached to the opposite second surface 122.

Various materials can be used for the board element 120. For example, the board element 120 can be made from a material that involves cutting processes, such as a MDF (medium-density fiber) board or stone (mineral matter), etc., or if necessary, a material that involves molding processes, such as glass, metal, synthetic resin, etc.

The surface laminate 110 can serve as the finishing material for the panel 100, and thus can be imbued with various colors, patterns, or decorations by way of printing, etc. The surface laminate 110 can be formed with a relatively small thickness and thus may have a relatively flexible quality.

Each of the folding grooves 130 formed in the board element 120 can include two triangular grooves 140. The two triangular grooves 140 may be formed adjacent to each other and may have symmetric shapes. Each triangular groove 140 may be formed in a triangular shape with both sides having substantially the same lengths, and thus may be shaped as an isosceles triangle. As will be described later in further detail, the board element 120 may be folded at each of the folding grooves 130, and due to the two triangular grooves 140, the opposite side of a fold may form a chamfer 115.

Forming chamfers 115 in the panel 100 and consequently removing sharp edges can provide greater safety during use of the panel 100, prevent damage to the surface laminate 110, and improve the appearance of the panel 100. In particular, since the board element 120 is folded at the folding grooves 130 and the surface laminate 110 faces outward, the surface laminate 110 forming the chamfers 115 can provide smoother edges.

Referring to FIG. 2B, the load-bearing element 150 can take the form of a frame composed of a multiple number of linear members. The linear members can include longitudinal members 152 arranged along the longitudinal direction of the panel 100 on both sides and lateral members 152′ arranged between these longitudinal members 152.

When an object is placed on a completed panel 100, the board element 120 can bear a certain amount of load, but by including the load-bearing element 150, the panel 100 can be made to bear a greater amount of load. In the case of a bookcase shelf, for example, a panel using MDF (medium-density fiber) material may require a thickness of 12 to 35 mm to support a corresponding load, but when a load-bearing element 150 is used, the board element 120 surrounding the load-bearing element 150 can be implemented with MDF material having a thickness of 3 mm or lower and still support the design load.

By forming the load-bearing element 150 in a ladder-like shape as described above, the load-bearing element 150 can bear a large load, even though most of the volume occupied by the load-bearing element 150 is empty space. Therefore, the amount of raw material used for fabricating the panel 100 can be reduced.

A panel 100 according to an embodiment of the invention can have coupling indentations (not shown) for coupling with other panels, and the coupling indentations can be formed in positions where the load-bearing element 150 is disposed. Thus, even if the load-bearing element 150 is composed of linear members 152, 152′ and a large portion inside the panel 100 is empty, the load-bearing element 150 would be present at the joint portions where the panel couples to other panels, to transfer the load and maintain a stable structure.

Of course, it is not necessary for the load-bearing element 150 to have the frame structure described above. In an embodiment of the invention, the load-bearing element 150 can take the form of a mesh assembled to a certain height with a multiple number of steel wires, etc., or take the form of a flat element processed to a certain height from wood, etc.

In certain embodiments of the invention, it is also possible to omit the load-bearing element 150. In such cases, the thickness of the board element 120 can be increased, compared to the cases of using a load-bearing element 150, so that the board element 120 itself may bear the load. In embodiments in which the load-bearing element 150 is omitted, the board element 120 can be folded in the shape of the panel with a hollow space formed inside, or the board element 120 can have a thickness corresponding substantially to one half of the intended thickness of the panel, so that the board element 120 can be folded twice and overlaid onto itself.

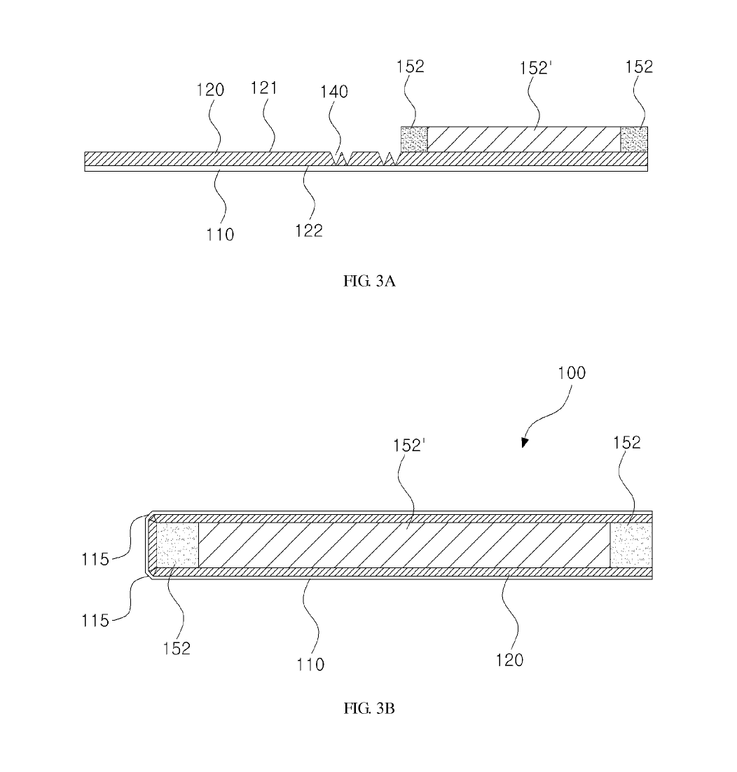

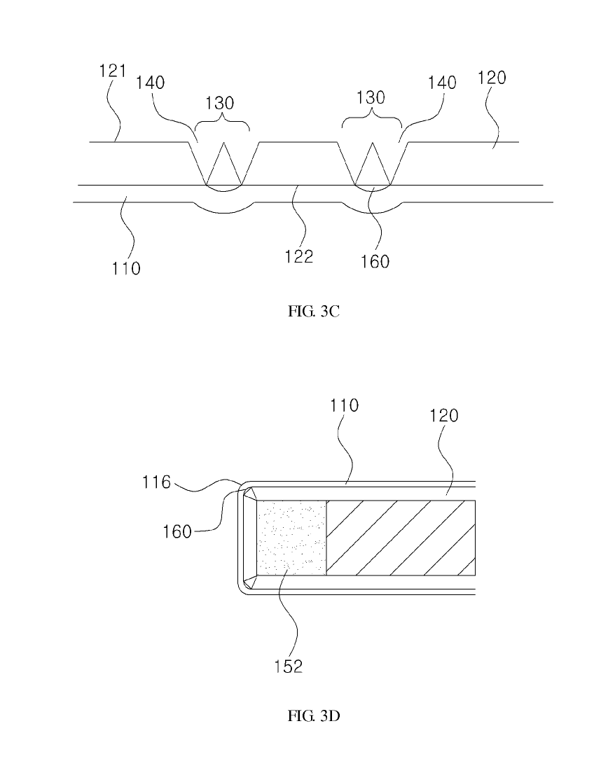

FIG. 3A is a cross-sectional view illustrating the board element of FIG. 2A and the load-bearing element of FIG. 2B arranged one over the other, and FIG. 3B is a cross-sectional view illustrating the board element of FIG. 3A folded at the folding grooves to cover the load-bearing element.

Referring to FIG. 3A, the length of the load-bearing element 150 may correspond to the length of the board element 120 in the direction in which the triangular grooves 140 extend in the first surface 121 of the board element 120, while the width of the load-bearing element 150 may correspond to the distance between the point where a triangular groove 140 begins on the first surface 121 of the board element 120 to the end portion of the board element 120 along a direction orthogonal to the direction in which the triangular grooves 140 are formed. The load-bearing element 150 may be arranged such that one side is adjacent to the triangular grooves 140 and the other side is positioned at the end portion of the board element 120.

Here, the thickness of the load-bearing element 150 may correspond to the distance between two folding grooves 130, i.e. the distance between the two middle triangular grooves 140 of the two folding grooves 130 that are not adjacent to each other. The thickness of the load-bearing element 150, the thickness of the board element 120 at the top and bottom, and the thickness of the surface laminate 110 at the top and bottom would substantially add up to the thickness of the corresponding panel 100.

Referring to FIG. 3B, the board element 120 and the surface laminate 110 may be folded twice along the two folding grooves 130 formed in the first surface 121 of the board element 120 to cover the load-bearing element 150. As the board element 120 and the surface laminate 110 are thus folded, the portion between the two triangular grooves 140 for each folding groove 130 may form a chamfer 115 on the outer side of the surface laminate 110.

When the board element 120 and the surface laminate 110 are folded to cover the load-bearing element 150, the board element 120 can be fastened to the load-bearing element 150 to complete the panel 100 according to an embodiment of the invention. Various methods can be used to fasten the board element 120 to the load-bearing element 150.

In cases where an adhesive material is used to fasten the board element 120 to the load-bearing element 150, the adhesive material can be coated on portions of the load-bearing element 150. This can provide a maximum amount of attachment area between the board element 120 and the load-bearing element 150 while minimizing the amount and preventing wasteful use of the adhesive material. In cases where an adhesive material is used, attaching the board element 120 and the load-bearing element 150 can be followed by a hot-pressing process to dry the adhesive material and secure the board element 120 and load-bearing element 150 in their proper positions.

If the material used for the board element 120 is a moldable material, the material itself can serve as an adhesive material. For example, if the board element 120 is made from a synthetic resin and the load-bearing element 150 is formed as a mesh of metal wires, the folding grooves 130 can be formed while the board element 120 is in a semi-cured state, after which the board element 120 can be folded such that the metal mesh is pressed into the semi-cured synthetic resin, in order that the synthetic resin may join with the metal mesh when it hardens.

FIG. 3C is a cross-sectional view illustrating a board element with rounding pieces added according to an embodiment of the invention, and FIG. 3D is a cross-sectional view illustrating the board element of FIG. 3C folded at the folding grooves to cover the load-bearing element.

As described above, the board element 120 can be folded after forming folding grooves 130 in the board element 120, to form chamfers 115 at the edges. Because of the chamfers 115, the angles at the corners are more obtuse compared to edges that do not have chamfers 115, thereby providing advantages in terms of user convenience and preventing damage. To provide even smoother edges on the panel 100, a method of adding rounding pieces 160 to the second surface 122 of the board element 120 can be considered. Folding the board element 120 after adding the rounding pieces 160 as illustrated in FIG. 3C and FIG. 3D can provide rounded edges 116 instead of chamfered edges.

A rounding piece 160 can be formed on the second surface 122 of the board element 120 between points corresponding to the vertexes of the two triangular grooves 140, i.e. between the points opposite the vertexes of the two triangular grooves 140 formed in the first surface 121. As illustrated in FIG. 3C, the cross section of a rounding piece 160 can be shaped as a circular segment.

The rounding pieces 160, which may extend along the longitudinal direction of the panel 100 being fabricated, can be attached to the second surface 122 of the board element 120 before forming or coupling the surface laminate 110 on the board element 120, so that the surface laminate 110 may form rounded edges after the board element 120 is folded. Of course, it is also possible to add the rounding pieces 160 onto the outward side of the surface laminate 110 for easier processing.

Supposing that the angle by which the board element 120 is folded is 90°, the rounded edge can be provided in a natural curve by implementing the arc portion of the rounding piece 160 with the curvature of a semi-circle having a diameter corresponding to the chamfer 115 portion. Of course, the shape of the arc of the rounding piece 160 may vary according to the folding angle and according to various designs.

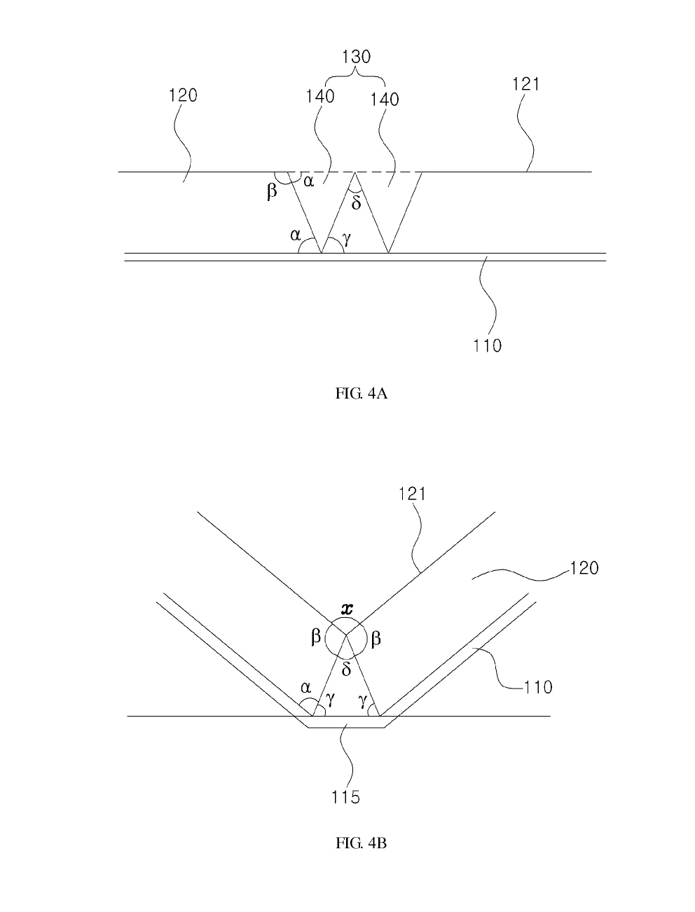

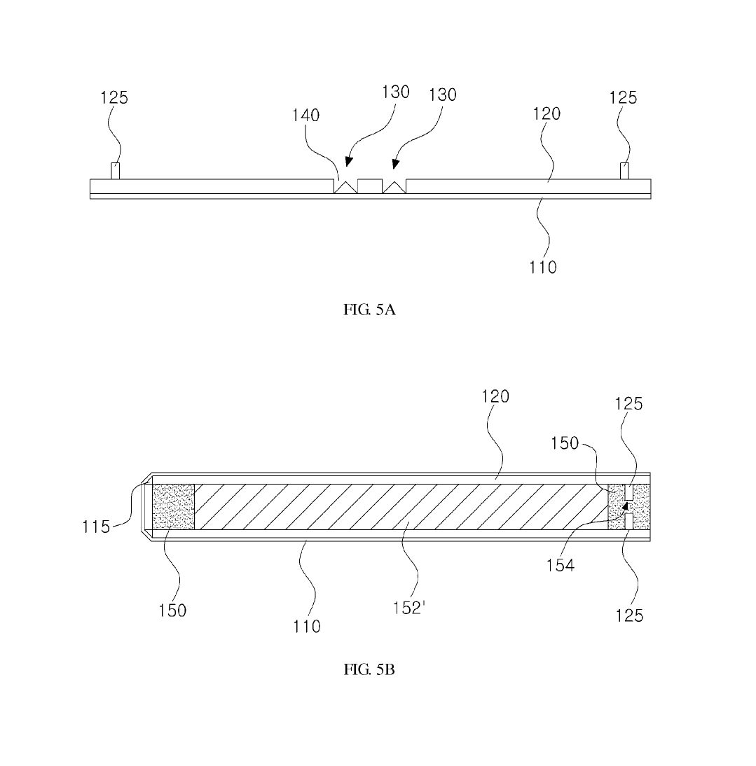

FIG. 4A and FIG. 4B are conceptual diagrams examining the relationships between the angles formed in a folding groove according to an embodiment of the invention.

The board element 120 may be folded at the folding grooves 130, each of which may be composed of two triangular grooves 140, to form chamfers 115 at the folded edges. The thickness is the same at both sides of a fold. Thus, in order to have both sides of the fold and the portion between the two triangular grooves 140 meet at a single point, as illustrated in FIG. 4B, it may be preferable to form each of the triangular grooves 140 with sides of equal lengths, i.e. as an isosceles triangle, and to have the two triangular grooves 140 be symmetrical to each other.

Supposing that the angle by which the board element 120 is to be folded is x, the angle between a side of a triangular groove 140 and the first surface 121 of the board element 120 is a, and the angle between a side of a triangular groove 140 and the second surface 122 is γ (see FIG. 4A and FIG. 4B), then the following Equation 1 holds for angle α and angle γ.

α=90°−γ+x/2 [Equation 1]

Referring to FIG. 4B, angle δ and angles γ form the three angles of a triangle, so that δ=180°−2γ. Angles β, which are supplementary angles to angle α, form 360 degrees with angle x and angle δ, so that δ=360°−x−2β.

As β is a supplementary angle of α such that 13=180°−α, the following equation holds.

180°−2γ=360°−x−2(180°−α)

Reducing the above equation results in Equation 1. If the thickness of the board element 120 is t, the desired width y for a chamfer 115 would be obtained by the equation below.

y=2t cot⁻¹γ

Thus, a desired width for the chamfer 115 can be obtained by setting the angles α and γ according to Equation 1.

In a typical example, the angle x by which the board element 120 is folded may be 90°, in which case Equation 1 can be reduced to the relationship shown below.

α=135°−γ

In the example illustrated in FIG. 2A, α and γ have the same value of 67.5°. Of course, various other angle arrangements can be used to obtain a 90° bend according to the relationship above, such as an α=90° and γ=45° combination, an α=75° and γ=60° combination, etc. However, if γ is made greater than a, the middle portion would have to be higher than the first surface 121, and as such, such a combination may not be desirable.

FIG. 5A is a perspective view illustrating a board element for a panel according to another embodiment of the invention, and FIG. 5B is a cross-sectional view illustrating a panel using the board element of FIG. 5A.

Referring to the example illustrated in FIG. 5A, in each of the two folding grooves 130 formed in the first surface 121 of the board element 120, the angles between the first surface 121 and the triangular grooves 140 are 90°, and the angles between the second surface 122 to which the surface laminate 110 is attached and the triangular grooves 140 are 45° (α=90°, γ=45°).

In this embodiment, the load-bearing element 150 has insertion grooves 154 formed thereon, while the board element 120 has protrusions 125 formed in positions corresponding to the insertion grooves 154. When the board element 120 is folded to cover the load-bearing element 150, the protrusions 125 can be inserted into the insertion grooves 154 to secure the board element 120 in relation to the load-bearing element 150.

The protrusions 125 and insertion grooves 154 can serve to couple the board element 120 and the load-bearing element 150 to each other and form a panel 100, or to simply align the board element 120 and the load-bearing element 150 in their proper positions, or to temporarily secure the board element 120 and the load-bearing element 150 when they are coupled by another means such as an adhesive material, etc.

FIG. 5B illustrates an embodiment in which the load-bearing element 150 is structured as a frame composed of a number of linear members 152, 152′. In this case, the insertion grooves 154 can be formed in an upper, lower, or side surfaces of certain linear members 152, 152′, while the protrusions 125 can be formed on the board element 120 in corresponding positions. When the board element 120 is folded, the protrusions 125 can be inserted into or latched onto the insertion groove 154 to secure the board element 120.

In embodiments where the load-bearing element 150 is implemented in the form of a wire mesh structure, the end of a protrusion 125 can be bent into a kind of hook, so that the protrusion may be hooked onto a wire to secure the board element 120.

In embodiments where the load-bearing element 150 is omitted and the board element 120 performs the load-bearing by itself, a protrusion 125 can be formed on one side of the board element 120 and an insertion groove can be formed in the other side, so that the protrusion 125 may be inserted into the insertion groove when the board element 120 is folded.

If the board element 120 and the load-bearing element 150 are to be coupled using only the protrusions 125 and insertion grooves 154, a relatively larger number of protrusions 125 and insertion grooves 154 may be used. On the other hand, if the protrusions 125 and insertion grooves 154 are for aligning or temporarily securing the board element 120 and load-bearing element 150, there may be a relatively fewer number of protrusions 125 and insertion grooves 154 or even just one protrusion 125 and one insertion groove 154.

While the descriptions above are provided for an example in which the protrusion 125 is formed on the board element 120 and the insertion groove 154 is formed in the load-bearing element 150, other embodiments may have the protrusion formed on the load-bearing element 150 and the insertion groove formed in the board element 120. Such embodiments also fall within the scope of the present invention.

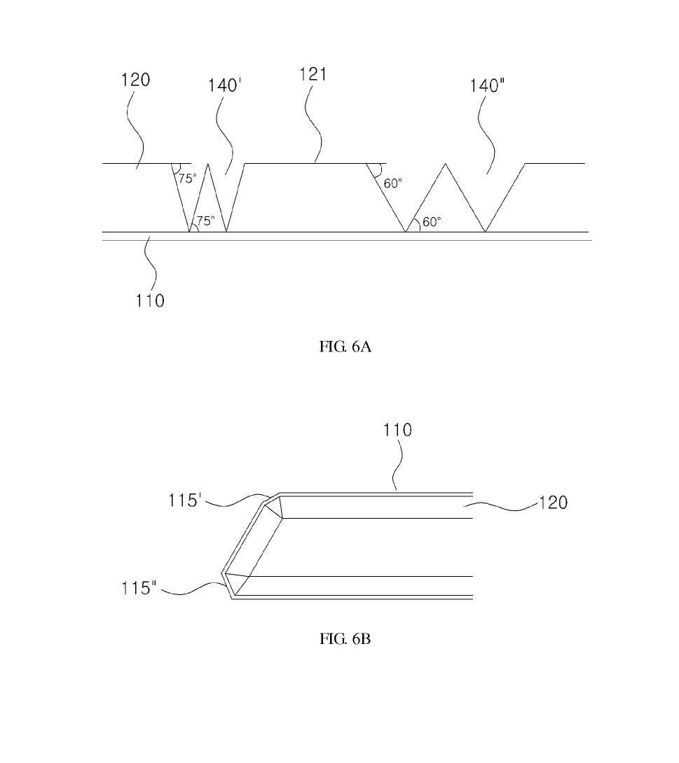

FIG. 6A is a perspective view illustrating a board element for a panel according to another embodiment of the invention, and FIG. 6B is a cross-sectional view illustrating a panel using the board element of FIG. 6A.

As illustrated in FIG. 6A, with respect to the folding grooves 130 formed in the board element 120, the two triangular grooves 140 formed in a single folding groove 130 can be formed symmetrically, but the folding grooves 130 themselves can take different shapes. In FIG. 6A, it can be seen that the triangular grooves 140′ of the left folding groove have different shapes and sizes from the triangular grooves 140″ of the right folding groove.

In particular, the angle by which the board element 120 is folded can be different at each folding groove 130, as illustrated in FIG. 6B. In FIG. 6B, the board element 120 is folded at an angle of 120° at the portion forming the chamfer 115′, while the board element 120 is folded at an angle of 60° at the portion forming the chamfer 115″. In this manner, the folding angle at each folding groove 130 can be set differently according to the usage of the panel 100, the shape of the load-bearing element 150, and so on.

While the drawings illustrate a typical example in which the board element 120 is folded twice to form a panel 100, the present invention is not thus limited. In various other embodiments, the board element 120 can be folded once or three times or more to implement a desired shape.

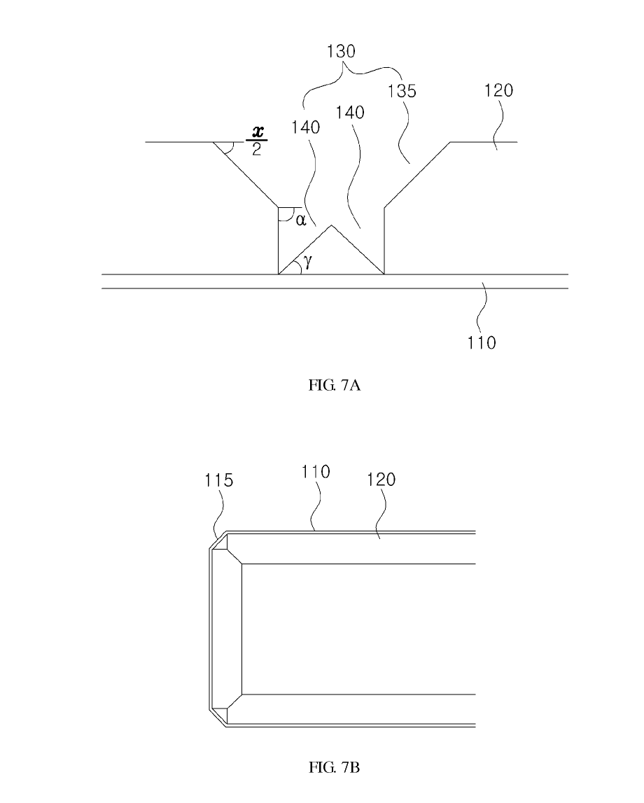

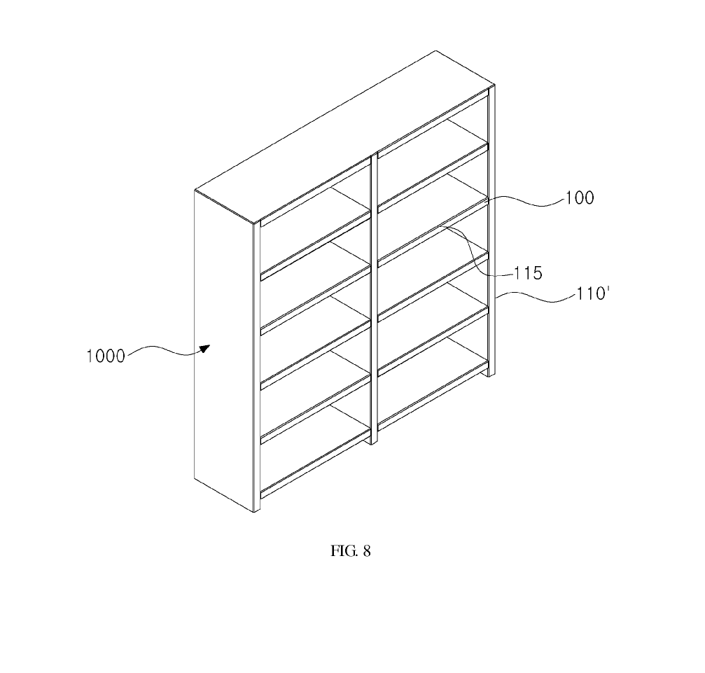

FIG. 7A is a cross-sectional view illustrating a folding groove in a panel according to another embodiment of the invention, and FIG. 7B is a cross-sectional view illustrating a portion of a panel using the board element of FIG. 7A.

As illustrated in FIG. 7A and FIG. 7B, the folding groove 130 formed in the first surface 121 of the board element 120 can include an auxiliary groove 135 that is relatively larger than the triangular grooves 140. The two triangular grooves 140 described above can be formed within the auxiliary groove 135.

In the case of forming the triangular grooves 140 directly in the first surface 121, the width y of the chamfer 115 formed at the surface laminate 110 is approximately y=2t cot⁻¹γ, depending not only on the angle γ between the triangular grooves 140 and the second surface 122 but also on the thickness t of the board element 120. Therefore, if the thickness t of the board element 120 is large, there is a limit to how small the width of the chamfer 115 can be made when forming the triangular grooves 140 in the first surface 121 directly.

Thus, when the thickness of the board element 120 is large, such as in embodiments where a relatively large-scale panel is being fabricated or embodiments where the load-bearing element 150 is omitted, the folding groove 130 can be made to include a relatively larger auxiliary groove 135, with the triangular grooves 140 formed within the auxiliary groove 135, in order to reduce the width of the chamfer 115.

Referring to FIG. 7A, the triangular grooves 140 may be formed at a lower position compared to the level corresponding to the thickness of the board element 120, and from the positions where the two sides of each triangular groove 140 form an isosceles triangle, the groove may be formed sloping towards the first surface 121. Here, if the board element 120 is to be folded by an angle of x, the angle formed between the auxiliary groove 135 and the first surface 121 may be x/2.

In other words, the auxiliary groove 135 may be formed first in the first surface 121 of the board element 120 at an angle corresponding to x/2, after which the triangular grooves 140 may be formed within the auxiliary groove 135. As already described above, the triangular grooves 140 can be formed such that the angle α between one side of a triangular groove 140 and the first surface 121 of the board element 120 and the angle γ between one side of the triangular groove 140 and the second surface 122 satisfy the relationship α=90°−γ+x/2.

FIG. 7B shows a chamfer 115 that may be formed when the folding groove 130 is made to include an auxiliary groove 135 as described above. As shown in FIG. 7B, the width of the chamfer 115 can be made considerably smaller compared to the thickness of the board element 120.

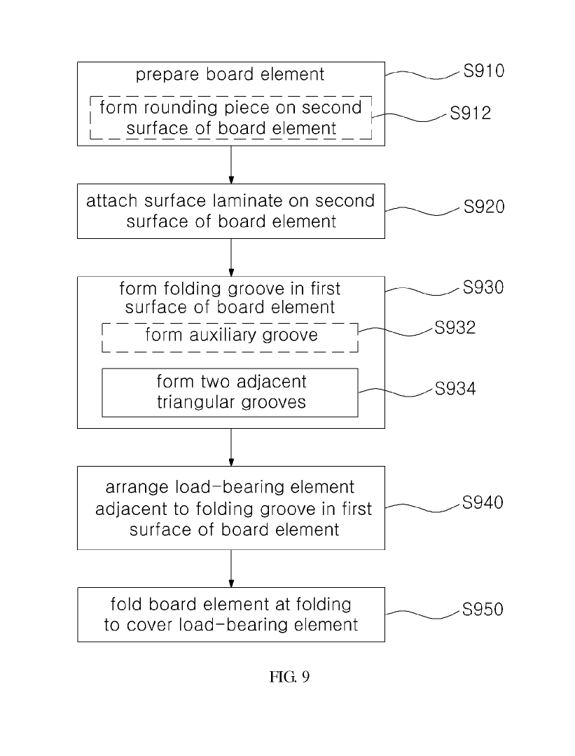

FIG. 8 is a perspective view illustrating a bookcase according to an embodiment of the invention.

A bookcase 1000 according to an embodiment of the invention can be formed by assembling several of the panels 100 described above. To this end, some of the panels 100 can include coupling indentations (not shown) for coupling with other panels. A coupling indentation can be formed in a position where the load-bearing element 150 is arranged. Thus, even when the load-bearing element 150 is composed of linear members 152, 152′ such that a considerable portion inside the panel 100 is hollow, the load-bearing element 150 may be present at the joints when the panel 100 is coupled to another panel, thereby maintaining a stable structure.

A bookcase 1000 according to an embodiment of the invention may be assembled with the panels 100 arranged such that the chamfered edges face forward. Thus, by forming chamfers 115 in the panels 100 and removing sharp edges, the bookcase 1000 can be used with greater safety, damage to the surface laminate 110 can be reduced, and the aesthetic appearance of the bookcase 1000 can be improved.

FIG. 9 is a flowchart illustrating a method of fabricating a panel according to an embodiment of the invention.

To fabricate a panel 100, a board element 120 can first be prepared (S910), where the surface that will be located relatively inside the panel 100 will be referred to as the first surface 121 of the board element 120, and the surface that will be located relatively outside the panel 100 will be referred to as the second surface 122 of the board element 120. Various materials can be used for the board element 120. For example, the board element 120 can be made from a material that involves cutting processes, such as a MDF (medium-density fiber) board or stone (mineral matter), etc., or if necessary, a material that involves molding processes, such as glass, metal, synthetic resin, etc.

Preparing the board element 120 (S910) can include forming a rounding piece 160 on the second surface 122 of the board element 120 (S912). A rounding piece 160 can be formed or coupled on the second surface 122 of the board element 120 between the points corresponding to the vertexes of two triangular grooves 140, i.e. between the points opposite the vertexes of the two triangular grooves 140 formed in the first surface 121. The rounding piece 160 can have a cross section shaped as a circular segment and can extend along the longitudinal direction of the panel 100 being fabricated. The step of forming the rounding piece 160 (S912) can be included or omitted as necessary.

Next, a surface laminate 110 can be attached to the second surface 122 of the board element 120 (S920). The surface laminate 110 can serve as the finishing material for the panel 100, and can be imbued with various colors, patterns, or decorations by way of printing, etc. The surface laminate 110 can be formed with a relatively small thickness and thus may have a relatively flexible quality.

Then, at least one folding groove 130 can be formed in the first surface 121 of the board element 120 (S930). According to the desired width of the chamfer 115, this can include or omit a step of forming an auxiliary groove 135 of a relatively larger size (S932). One folding groove 130 may include two adjacent triangular grooves 140, and as such, the procedure for forming the folding groove 130 in the first surface 121 of the board element 120 may include a procedure for forming two adjacent triangular grooves 140 in the first surface 121 of the board element 120 (S934).

The auxiliary groove 135 and the two triangular grooves 140, which can be included in a single folding groove 130, can be formed sequentially or simultaneously. For example, if a MDF wood board is used for the board element 120, an auxiliary groove 135, one triangular groove 140, and the other triangular groove 140 can be formed in the first surface 121 by cutting with one or more blades that match the corresponding angles.

In another embodiment, if a thermally fusible metal is used for the board element 120, an auxiliary groove 135, one triangular groove 140, and the other triangular groove 140 can be formed in the first surface 121 while the board element 120 is in a semi-hardened state by pressing with one or more pressing instruments that match the corresponding angles. In this case, attaching the surface laminate 110 to the second surface 122 of the board element 120 (S920) can include casting the material of the board element while in a molten state onto the surface laminate 110 for the attaching.

Next, a load-bearing element 150 can be arranged on the first surface 121 of the board element 120 at a position adjacent to the folding groove 130 (S940). The load-bearing element 150 can have the structure of a frame composed of several linear members. These linear members can include longitudinal members 152 arranged along the longitudinal direction of the panel 100 on both sides and lateral members 152′ arranged between the longitudinal members 152. In addition, the load-bearing element 150 can take the form of a mesh of metallic wires assembled to a particular height, or take the form of a flat member made of wood, etc., processed to a particular height.

Arranging the load-bearing element 150 (S940) can include first applying an adhesive material on the load-bearing element 150.

Finally, the board element 120 can be folded at the folding grooves 130 to cover the load-bearing element (S950). As the board element 120 is folded, the surface laminate 110 may be positioned at an outward side, and chamfers 115 may be formed at the portions corresponding to the folding grooves 130. By thus forming chamfers 115 in the panel 100 and removing sharp edges, there can be increased safety during use of the panel 100, damage to the surface laminate 110 can be mitigated, and the appearance of the panel 100 can be improved. In particular, since the board element 120 is folded at the folding grooves 130 such that the surface laminate 110 is positioned outside, the chamfers 115 formed by the surface laminate 110 can have smoother edges.

As described above, embodiments of the present invention can minimize the use of materials in portions inside the panel that do not play critical roles in load-bearing, and chamfers can be formed at desired edges. The panel fabricated by a simple method using a smaller amount of material can provide high structural stability and durability while improving user convenience and aesthetic appearance.

While the present invention has been described above using particular examples, including specific elements, by way of limited embodiments and drawings, it is to be appreciated that these are provided merely to aid the overall understanding of the present invention, the present invention is not to be limited to the embodiments above, and various modifications and alterations can be made from the disclosures above by a person having ordinary skill in the technical field to which the present invention pertains. Therefore, the spirit of the present invention must not be limited to the embodiments described herein, and the scope of the present invention must be regarded as encompassing not only the claims set forth below, but also their equivalents and variations.

What is claimed is:

1. A panel comprising:
a board element formed from a rigid material and having at least one folding groove formed in a first surface thereof; and
a surface laminate formed from a flexible material and coupled to a second surface of the board element opposite the first surface of the board element,
wherein the folding groove comprises two triangular grooves formed adjacent to each other, the triangular grooves formed symmetrically to each other and each formed in a triangular shape with sides of substantially equal length,
and the board element is folded at a particular angle at the folding groove such that the surface laminate is positioned outward and a chamfer is formed at a portion corresponding to the folding groove.

2. The panel of claim 1, wherein an angle between a first side of the triangular groove and the first surface and an angle between a second side of the triangular groove and the second surface satisfy an equation shown below:
α=90°−γ+x/2,
wherein α is the angle between the first side of the triangular groove and the first surface, γ is the angle between the second side of the triangular groove and the second surface, and x is the angle by which the board element is folded at the corresponding folding groove.

3. The panel of claim 2, wherein the folding groove further comprises an auxiliary groove, the two triangular grooves are formed within the auxiliary groove, and an angle between a side of the auxiliary groove and the first surface forms an angle of x/2, where x is the angle by which the board element is folded at the corresponding folding groove.

4. The panel of claim 1, further comprising:
a rounding piece positioned on the second surface of the board element between points corresponding to vertexes of the two triangular grooves,
wherein the rounding piece has a cross section shaped as a circular segment and extends along a longitudinal direction of the panel.

5. A panel comprising:
a board element formed from a rigid material and having at least one folding groove formed in a first surface thereof;
a surface laminate formed from a flexible material and coupled to a second surface of the board element opposite the first surface of the board element; and
a load-bearing element coupled to the first surface of the board element,
wherein the folding groove comprises two triangular grooves formed adjacent to each other, the triangular grooves formed symmetrically to each other and each formed in a triangular shape with sides of substantially equal length,
and the board element is folded at a particular angle at the folding groove to cover the load-bearing element such that the surface laminate is positioned outward and a chamfer is formed at a portion corresponding to the folding groove.

6. The panel of claim 5, wherein an angle between a first side of the triangular groove and the first surface and an angle between a second side of the triangular groove and the second surface satisfy an equation shown below:
α=90°−γ+x/2,
wherein α is the angle between the first side of the triangular groove and the first surface, γ is the angle between the second side of the triangular groove and the second surface, and x is the angle by which the board element is folded at the corresponding folding groove.

7. The panel of claim 6, wherein the folding groove further comprises an auxiliary groove, the two triangular grooves are formed within the auxiliary groove, and an angle between a side of the auxiliary groove and the first surface forms an angle of x/2, where x is the angle by which the board element is folded at the corresponding folding groove.

8. The panel of claim 5, further comprising:
a rounding piece positioned on the second surface of the board element between points corresponding to vertexes of the two triangular grooves,
wherein the rounding piece has a cross section shaped as a circular segment and extends along a longitudinal direction of the panel.

9. The panel of claim 5, wherein the load-bearing element comprises linear members fixed in relation to one another,
and the linear members include longitudinal members arranged along a longitudinal direction of the panel at both sides and lateral members arranged along a lateral direction of the panel between the longitudinal members.

10. The panel of claim 9, wherein the board element is attached to the load-bearing element by way of an adhesive material coated on at least a portion of the linear members.

11. The panel of claim 9, wherein the panel has at least one coupling indentation for coupling with another panel, the coupling indentation formed in a position where the linear member is arranged.

12. The panel of claim 5, wherein the load-bearing element comprises at least one insertion indentation,
and the board element comprises at least one protrusion in a position corresponding to the insertion indentation,
such that the protrusion is inserted into the insertion indentation when the board element is folded, to secure the board element in relation to the load-bearing element.

13. A bookcase formed by coupling a plurality of panels, wherein at least one of the panels comprises a board element formed from a rigid material and having at least one folding groove formed in a first surface thereof, a surface laminate formed from a flexible material and coupled to a second surface of the board element opposite the first surface of the board element, and a load-bearing element coupled to the first surface of the board element,
the folding groove comprises two triangular grooves formed adjacent to each other, the triangular grooves formed symmetrically to each other and each formed in a triangular shape with sides of substantially equal length,
the board element is folded at a particular angle at the folding groove to cover the load-bearing element such that the surface laminate is positioned outward and a chamfer is formed at a portion corresponding to the folding groove,
and at least one of the panels is arranged such that a portion corresponding to the folding groove is positioned at a front of the bookcase.

14. The bookcase of claim 13, wherein an angle between a first side of the triangular groove and the first surface and an angle between a second side of the triangular groove and the second surface satisfy an equation shown below:
α=90°−γ+x/2,
wherein α is the angle between the first side of the triangular groove and the first surface, γ is the angle between the second side of the triangular groove and the second surface, and x is the angle by which the board element is folded at the corresponding folding groove.

15. The bookcase of claim 14, wherein the folding groove further comprises an auxiliary groove, the two triangular grooves are formed within the auxiliary groove, and an angle between a side of the auxiliary groove and the first surface forms an angle of x/2, where x is the angle by which the board element is folded at the corresponding folding groove.

16. The bookcase of claim 13, further comprising:
a rounding piece positioned on the second surface of the board element between points corresponding to vertexes of the two triangular grooves,
wherein the rounding piece has a cross section shaped as a circular segment and extends along a longitudinal direction of the panel.

17. The bookcase of claim 13, wherein the load-bearing element comprises linear members fixed in relation to one another,
and the linear members include longitudinal members arranged along a longitudinal direction of the panel at both sides and lateral members arranged along a lateral direction of the panel between the longitudinal members.

18. The bookcase of claim 17, wherein the board element is attached to the load-bearing element by way of an adhesive material coated on at least a portion of the linear members.

19. The bookcase of claim 13, wherein the load-bearing element comprises at least one insertion indentation,
and the board element comprises at least one protrusion in a position corresponding to the insertion indentation,
such that the protrusion is inserted into the insertion indentation when the board element is folded, to secure the board element in relation to the load-bearing element.

20. The bookcase of claim 17, wherein the panels are coupled to one another at positions where the linear members are arranged.

21. A method of fabricating a panel, the method comprising:
preparing a board element having a first surface and a second surface, the first surface to form an inside and the second surface to form an outside;
attaching a surface laminate to the second surface of the board element;
processing at least one folding groove in the first surface of the board element, the folding groove comprising two adjacent triangular grooves;
arranging a load-bearing element on the first surface of the board element adjacent to the folding groove; and
folding the board element at the folding groove to cover the load-bearing element such that the surface laminate is positioned outward and a chamfer is formed at a portion corresponding to the folding groove.

22. The method of claim 21, wherein the preparing of the board element comprises:
coupling a rounding piece to the second surface of the board element between points corresponding to vertexes of the two triangular grooves,
wherein the rounding piece has a cross section shaped as a circular segment and extends along a longitudinal direction of the panel.

23. The method of claim 21, further comprising, before the arranging of the load-bearing element:
coating an adhesive material on at least a portion of the load-bearing element.
